(19) United States
(12) Patent Application Publication
(10) Pub. No.: US 2013/0268439 A1
(43) Pub. Date: Oct. 10, 2013

(54) VTEX3 FRAUD PROTECTION SYSTEM MOBILE VERIFICATION PROTOCOL (MVP)

(71) Applicant: Desmond R Lowe, Ellicott City, MD (US)

(72) Inventor: Desmond R Lowe, Ellicott City, MD (US)

(21) Appl. No.: 13/716,145

(22) Filed: Dec. 16, 2012

Related U.S. Application Data
(60) Provisional application No. 61/620,863, filed on Apr. 5, 2012.

(51) Int. Cl. G06Q 20/42

(52) U.S. Cl. CPC G06Q 20/42
USPC 705/44

(57) ABSTRACT

The methods and systems for providing fraud protection and prevention of Identity theft, referred to as Personal Information Owner (PIO) to an user involving a transaction into an application server and application associated with customer mobile/portable communication device through a multi step verification process, the system allow users for controlling and managing of pre and post verification of all transaction/Personal Information Owner (PIO) based requests or personal information and providing the holder/user full control of confidential information. This system or process has the advantage of pre-screening any process request made against the user's information.

### CROSS REFERENCE TO RELATED APPLICATIONS

This application claims priority of U.S. Provisional Application No. 61620863, titled ‘VTEX³ FRAUD PROTECTION SYSTEM MOBILE VERIFICATION PROTOCOL (MVP)’, filed on Apr. 5, 2012, which is incorporated by reference herein in its entirety and for all purposes.

### FIELD OF THE INVENTION

This invention relates generally to fraud protection system and method more specifically to provide the holder/user control of confidential information by managing such information through a verification process.

### BACKGROUND OF THE INVENTION

An example of such would read as follows: During a payment transaction using a payment card (e.g., a credit, debit, or stored value card), it is important to verify a cardholder's ownership of an account to avoid a variety of problems, such as unauthorized use. Payer authentication is the process of verifying a cardholder's ownership of an account. The most common method to authenticate a cardholder's ownership of an account occurs routinely at a point of sale during what is called a “card present” transaction. A card present transaction involves a merchant's representative taking the cardholder's card, swiping it though a payment card terminal to verify account status and credit line availability, and then checking to see that the signature on the back of the card matches the purchaser's signature. Comparison of the signatures provides authentication of account ownership.

Card not present” transactions, on the other hand, such as those occurring online, through mobile, through the mail, or over the telephone, involve payments that are not guaranteed to the merchant. Online transactions include those that are conducted, for example, over the Internet. No guarantee is provided primarily because the payers are not authenticated in such non face-to-face transactions, thereby allowing many risks to accompany the “card not present” transactions. Such risks involve issues such as charge backs of payment transactions to online merchants, fraud for both merchants and cardholders, increased exception item processing expenses for banks, and an increased perception that buying goods and services online or through mobile is not safe and secure, preventing prospective consumers from buying online. Other examples of risks include the unauthorized use of stolen account information to purchase goods and services online, fabrication of card account numbers to make fraudulent online purchases, and extraction of clear text account information from network traffic.

Multi-device user account authentications allow for example, a first unit to authenticate a user with a web server, to provide first level authentication for user of the first unit that is initiating an electronic transaction. The first device may have the user enter a password and PIN. A second level of authentication may be provided using a second device such as a user's cell phone wherein the web server sends a second level authentication code (such as a onetime pass code) to the mobile device using a wireless SMS/back channel. The user then reads the authentication code from the mobile device and enters it into the first unit as a second level of authentication to authenticate the user to the web server. The authentication code from the mobile device may also be automatically sent wirelessly to the first unit that initiated the transaction. However, once the user has been authenticated and a transaction is carried out after user authentication, this layer protects against malware that can interfere with a unit's web browser to change transaction information such as dollar amounts for a wire transfer and the like causing the computer to send account information or wire money to a rogue site or account. Also the aforementioned out of band pass code technique involves sending a pass code that is not tied to details of the transaction.

Another system which has been developed is one in which the circuitry of the mobile telephone is programmed to incorporate the customer's bank account number and may contain “consistency information” of the customer's bankcard. Accordingly, the system functions by means of the bank account number (or bankcard number) being transmitted by the mobile for the purposes of effecting the financial transactions A problem with this system is that it also involves a low level of security with the relevant bank account details being transmitted and subject to interception by unauthorized persons.

Also to maintain security, the personal identities of users may be authenticated. The personal identity may be authenticated by the input of user information using an IC card which has user information recorded in it, or by the input of a password by the user. Furthermore, there have been many proposals of applying personal identity authentication configuration to image forming apparatuses.

In addition, while sending private and confidential information to the authenticated person, the security protection is more likely incomplete, with the likelihood of the printed material being seen or stolen by a third person .

Given the continued expected high growth of electronic commerce, it is important to provide methods to authenticate payers. This will benefit all payment system participants including cardholders, merchants, and financial institutions. Authenticating the payer during online payment transactions will reduce the levels of fraud, disputes, retrievals and charge-backs, which subsequently will reduce the costs associated with each of these events.

User must give credit card information to the merchant over the phone or online, leaving the door open for electronic fraud which has grown by 40% in the last two years. PayPal is a third party transaction gateway in which user turns their information over to PayPal, who acts on behalf of user to transact with merchant. User sets up a PayPal account prior to entering into a transaction and a merchant bank account, tying PayPal to user's credit card or establishing a credit with PayPal, and PayPal serves as a debit card for the user. You may also have a credit card issued by PayPal after using the debit system for 30 days which is attached to user's bank account.

Bill-Me-Later is another option where Bill-me-Later interacts with the merchant on behalf of user to transact. The user then pays Bill-me-Later later on terms, as they would pay off a credit card.

Due thereto, recently, research into a new software application method capable of not only improving the security of transaction information of each person but also satisfying both the security and convenience of transactions using mobile/portable communication device has been actively conducted, with the recent tendency for mobile/portable communication device to become popular.

The inventions disclosed herein are directed to an improved method and system that employ authentication techniques, providing the holder/user full control of confidential information and managing such information through a verification process, (information such as: financials, credit information, social media securities, document(s), funds transfer data, social security number and or information exchanged transactions, grant access on request/demand and other types of transaction(s) performed electronically as it relates to the owner of such confidential information that makes up his/her digital life) within a secured system.

### SUMMARY OF THE INVENTION

The present disclosure relates to an improved, simplified and novel system and method that employ authentication techniques, providing the holder/user full control of confidential information by managing such information through a verification process, (information such as: financials, credit information, social media securities, document(s), funds transfer data, social security number and or information exchanged transactions, grant access on request/demand and other types of transaction(s) performed electronically as it relates to the owner of such confidential information that makes up his/her digital life within a secured system.

One aspect of the present invention is fraud protection method and system, providing additional security for financial transactions including but not limited to credit card transactions or prevention of Identity theft, referred to as Personal Information Owner hereafter referred to as PIO, where an authorized user is linked to a transaction by a highly secure software application. The method comprising: storing and editing of card holder or user's information into an application server; controlling and managing of pre and post verification for all transaction/PIO based requests; generating a transaction confirmation code based on the received transaction information in response to a transaction for user verification; sending the transaction code for permission to continue the transaction which enables the user to accept or decline the transaction; transmitting authentication preparation and confirmation step information obtained from user to payment gateway server for sequential processing; requesting transaction confirming request, confirmation of transaction by user; and providing electronic transaction details or summary receipt for evaluation by user.

Another aspect of the present invention pertains to a system capable of supporting the method described just prior. This system allows verifying authorization of a person identification through mobile verification protocol (MVP) providing card holder or user with pre and post verification for all transactions or personal information updates, inputs , changes or anything specific to holder or user , the method comprising: creating preferences for information of account or personal information, personal identification number and dynamic verification code (DVC); providing authorization security for all financial transaction; alerting user regarding transaction, notification is transferred to user mobile/portable communicating device application from the moment transaction initiated; validating and verifying authorization for each transaction; and a response returned as to success or failure related to transaction information provided by user to merchant server.

Yet another aspect of the present invention gives Personal Information Owner [PIO] this additional layer of protection/involvement in transactional processes, minimizing or eliminating the possibility of fraudulent activity. The method and system is transactional based; giving this system or process the advantage of screening any process request made against the user's information.

A method for providing full disclosure of confidential information by managing such information of user thru Institution Verification Process (IVP), comprising of:
a user/holder making a call to an institution where his/her information has MVP [mobile/portable verification protocol] associated to such account, this process assists the intuition in qualifying thru MD-verify (mobile device verification) is conducted without alerting the user or explaining how and what MD-verify works) the user/holder while protecting the owner's personal information. This mobile verification protocol is designed to proactively assist, notify, verify and alert the PIO [Personal Information Owner] to be included in the IVP or usage of his/her information.

### BRIEF DESCRIPTION OF THE DRAWINGS

The following invention will be described with reference to the following drawings of which:

FIG. 1 shows VteX³ flow process of the disclosed invention.

Table 1 to 6 shows VteX³ purchase controlled process window's screen diagram of the disclosed invention.

FIGS. 2 to 8 shows process of VteX³ fraud protection system and method for protecting all transaction/Personal Information Owner (PIO) based requests or personal information.

FIG. 9 to FIG. 18 shows VteX³ app in mobile/portable communication device where the process and functional step for protection of all cards.

### DETAILED DESCRIPTION

The present invention will be described with respect to particular embodiments and with reference to certain drawings but the invention is not limited thereto but only by the claims. The drawings described are only schematic and are non-limiting. In the drawings, the size of some of the elements may be exaggerated or distorted and not drawn on scale for illustrative purposes. Where an indefinite or definite article is used when referring to a singular noun e.g. “a” or “an”, “the”, this includes a plural of that noun unless something else is specifically stated.

The present disclosure provides an exemplary embodiment of an improved, simplified and novel system and method that employ authentication techniques, providing the holder/user full control of confidential information by managing such information through a verification process, (information such as: financials, credit information, social media securities, document(s), funds transfer data, social security number and or information exchanged transactions, grant access on request/demand and other types of transaction(s) performed electronically as it relates to the owner of such confidential information that makes up his/her digital life within a secured system.

For the avoidance doubt, unless otherwise indicated, the term VteX³ is software application/server name for the fraud protection system.

The present description will begin with an overview of a core financials, credit information and account fraud protection system and method. The fraud protection system is provided as a service or application to participating issuers, account holders/users, and merchants. An implementation of the fraud protection system relating to online payment transactions is first described. The description of online payment transactions provides details about the fraud protection system and method that are analogous to the fraud protection system and method used for non-payment transactions. This is because both payment and non-payment transactions involve the authentication of a users or holder's identity. The implementations allow users or holders to use application on mobile/portable communication devices. The core fraud protection system forms the basis for the mobile/portable communication device implementations.

The fraud protection system/verification process is designed to authenticate cardholder account ownership during transactions in which one party cannot physically verify the identity of another party who purports to be the owner of a specific account. For example, the fraud protection system can be used in various transactions when a trusted party authenticates the identity of an individual or entity for the benefit of a third party. As is commonly known, the trusted party usually accepts legal responsibility for the authentication of the individual or entity to the third party. Certainly, one important application of the system is in the field of payment transactions that take place either online or over portable electronic devices.

A description of the system architecture for authenticating an account holder in the realm of payment transactions will now be provided. Note that many of the general concepts described in this section are applicable to various fields of use since the authentication process for providing the holder/user full control of confidential information, manages such information through a verification process, (information such as: financials, credit information, social media securities, document(s), funds transfer data, social security number and or information exchanged transactions, grant access on request/demand and other types of transaction(s) performed electronically as it relates to the owner of such confidential information that makes up his/her digital life) within a secured system.

The description will now provide further detail for setting up the fraud protection system for both payment and non-payment transactions. First, the procedures required to set up the various system participants such that they can use this system and method will be explained. Then the account holder's process for registering will be explained. After these phases are described, explanation will be provided as to the actual authorization of transactions.

Setting up the account fraud protection system that is VteX³ application involves set up procedures for all the participants within the system. The set-up procedures are generally the same for both the authorization of payment and non-payment transactions. These participants include entities such as merchants or other authentication requesting parties, financial institutions or other trusted parties, and account or card holders.

After all participants are set up and the account holders are registered, account authentication is performed. Account authentication can be performed in a variety of manners depending upon the particular systems utilized by the participants.

The present invention of fraud protection system and method for protection and prevention of Identity theft, referred to as Personal Information Owner (PIO), where an authorized user is linked to a transaction via a highly secure software application, comprising of:
storing and editing of card holder or user's information into an application server;
controlling and managing of pre and post verification for all transaction/Personal Information based requests;
generating a transaction confirmation code based on the received transaction information in response to a transaction for user verification;
sending the transaction code for permission to continue the transaction which enables the user to accept or decline the transaction;
transmitting authentication preparation and confirmation step, information obtained from user to payment gateway server for sequential processing;
requesting transaction confirming request, confirmation of transaction by user; and
providing electronic transaction details or summary receipt for evaluation by user.
   wherein the card/Personal Information Owner (PIO) includes all card but not limited to credit card, debit card, check cashing, personal identity card or shopping card.

An embodiment of the present invention the said software application is installed on user mobile/portable communication device, where the dynamic verification code (DVC) encoded in QR Code information is sent to user mobile/portable communication device which authenticates and validates the transaction prior to processing it.

Another aspect of the present invention provides VteX³ fraud protection system—mobile verification protocol (MVP) provides holder/user with pre and post verification for all transaction-based requests or personal information updates, inputs, changes or anything specific to the holder/user. VteX³ verification tools to the holder/user is considered mandatory in some embodiments, but is not considered mandatory in others. The user is in control of 3 vital areas of his/her information/monies or any other user request: 1) Account/personal information; 2) Personal Identification Number (PIN); and 3) dynamic verification code (DVC)/QRCode-[Quick response code] which is an alphanumeric code provided at time of transaction/information and/or at the time of request via his/her mobile/portable communication device or verification media. The process is as follows: the user upon completion of a transaction or request for information is prompted to review and authenticate the transaction request sent electronically to the mobile/portable device optionally provided then enter his/her 4-6 digit pin number, along with the time sensitive DVC/QrCode provided for this specific transaction. Upon completion, the user is provided with an archived summary receipt sent to a mobile/portable communication device. This transaction is optionally archived in Mobi-SORT (a mobile accounting software application) which is exportable for account filing.

Another aspect of the present invention provides a method of fraud protection, the method comprising of:
fraud protection to user by verifying authorization of a person identification through mobile verification protocol (MVP) providing card holder or user with pre and post verification for all transactions or personal information updates, inputs , changes or anything specific to holder or user , the method comprising:
creating preferences for information of account or personal information, personal identification number and dynamic verification code (DVC)or Quick response code (QRCode);
providing authorization security for all financial transaction including but not limited to credit card transactions;
alerting user regarding transaction, where notification is transferred to user mobile/portable communication device application when transaction is initiated;
validating and verifying authorization for each transaction; and a response returned as to success or failure related to transaction information provided by user to merchant server;
wherein mobile verification protocol(MVP) also provides assistance to physically challenged and the disabled to be able to use services via TTY operator to communicate.

Another aspect of the present invention is to provide additional security for financial transactions including but not limited to credit card transactions. This unique feature is an additional validation and verification required for each transaction. In addition to a typical card, key fob, credit card or data or identification object that represents the credit card being used for a transaction.

Another aspect of the present invention provides mobile/portable communication device application containing a program which provides protection against fraud, when executed, performs an operation, comprising:
collecting information about a user personal information, personal identification number and dynamic verification code (DVC) or Quick response code (QRCode);
securing user information to define transaction management criteria while the application provides full authority to personalize their transaction according to their use;
controlling and validating of authorization of each transaction by user;
creating associations among merchant, payment gateway and user; and
monitoring and managing of all transactions are by end user.

The purchaser will need to provide information including but not limited to billing information, account number, verification code and PIN. Once that transaction is validated and verified, a response will be returned as to success or failure related to transaction information shared.

An embodiment of the present invention is the challenges that come with baby boomer or disabled individuals and have provided detailed information on this aspect of our process. VteX³ Fraud protection system—mobile verification protocol (MVP) understands the challenges of the disabled. In some embodiments, models will allow individuals with hearing, visual or physical challenges to be able to use this service.

For example, in order for a TTY operator to communicate with a holder/user that is visually challenged, we will provide assistance in this process. These individuals typically log the details onto an encrypted database; this database would have an authenticating process unknown to the operator where this information would be held. Any similar form of validating, from financial transaction(s) for validation information transfer will be captured in this process. This process creates a continuous electronic footprint between e-commerce and e-information.

Another aspect of the present invention provides a method for full control of confidential information by managing such information in what is referred to as Multistep Verification Process—MvP, the method comprising:
performing a step of registering information capable of specifying the association between said real person and application server;
storing holder or user's information into an application server and application associated with customer mobile/portable communication device;
receiving of an information verification request from a requesting entity, authenticating information verification request,
transmitting an verification code to mobile/portable communication device communicating device associated with customer, wherein the response of the request of authorization is communicated to a requesting entity,
and transmitting at least one identification credential associated with the customer to requesting entity's virtual terminal

Another aspect of the present invention provides mobilizing VteX³ as an Application where VteX³ utilizes a Mobile/portable Verification Protocol (MVP) where financial information provided to complete any transaction, whether transferred by a user to a merchant by phone, [on phone transaction however require the merchant to selection the “ON PHONE” option which forward the ACCEPT or DENY option to the user/holder's mobile/portable communication device] online or at a merchant facility, the user or cardholder can opt to be provided with a dynamic verification code (DVC) generated from the VteX³ app installed on his/her mobile/portable communication device, where the dynamic verification code (DVC) is sent to authenticate and validate the transaction prior to processing.

Once the corresponding dynamic verification code (DVC), quick response code QRCode, ACCEPT/DENY and or PIN is inputted by user, the transaction is approved and user/card holder/purchaser will receive a confirmation text to his/her mobile/portable communication device confirming the transaction.

An example of VteX³ software/application working as a verification system can be applied to sectors that information database systems or other areas of concern relating to the preservation or regulation of the holder/users information. The structure of the program entails (for example) when a transaction commences, a merchant sends the first request, VteX³ receives the request, and then sends out (i) a pre approval acceptance/denial request to the holder. Once this is done (ii) the holder receives a QRCode/alphanumeric confirmation, verification on his or her mobile/portable communication device or other electronic device (iii) he/she then enters his 4-6 pin number to conclude the transaction. This represents the 3-factor authentication process

The holder can auto bypass any aspect of this procedure as he/she chooses to. VteX³ affords the holder of such information to choose the preferences to include timeline usage, geographic restrictions, proxy/guardian control options with relative accounts (mother, father, daughter, son, etc.)

In comparison to the present technologies in place to protect the holder/user, VteX³ insulates the user from potential liability using a proactive personal secure shield. VteX³ proactively safeguards the holder/user from post resolving procedures which the existing identity monitoring systems provide.

Consequently, this will significantly reduce the merchant need to absorb that shrinkage costs, or having to wonder/bear the liability cost associated with such fraudulent transactions. The fees that result from increased costs of transactions gone bad are no longer passed onto the holder/user or consumer as “the cost of doing business”.

This procedure will be adapted to other aspects where the user/holder's confidential information could be compromised, misused or misrepresented

Another aspect of the present invention provides to craft its software as a multi-channel mobile/portable communication device app that can be used across platforms. The mobile/portable communication device app market specialist sells VteX³ into the consumers/users which will prove the business model for processing payments, boosting the valuation for Verified Solution.

An embodiment of the present invention provides the advantages specifically for the users or holders. It is a three-factor verification system with enable the user of his/her information to be involved in all aspects relating to use of such information. VteX³ allows the user to create preferences namely notification and or authorization option as he/she chooses but not limited to OUT of STATE transactions, online charge shipped to a different address other than the user's, cash withdrawals outside of a specific zip code or State, check cashing, transaction over a specific dollar amount, Online purchases verification. —Using a 4-6 alphanumeric transactional code and or QR code, maximum charge limit—(restrictions on high ticket item purchases by a minor authorized by his/her parent or Guardian to conduct such transaction(s).

VteX³ is a unique software based process that allows a card holder, purchaser/Information owner (hereafter referred to as the “holder”) to be actively involved in regulating and securing all legal transactions (SALT).

When a “holder” makes a request to conduct purchases online or at a merchant facility such as a supermarket, as well as all other forms of purchases within the retail industry, the cardholder would be provided with a dynamic verification code (DVC) generated from the VteX³ software sent to his/her mobile/portable communication device which would be written—(thru a unique and proprietary coding encryption) into the purchasing cart/purchasing process of that specific financial institution. Institutions such as the banking industry—Visa, MasterCard, American Express, PayPal, just to name a few.

The “holder” would then complete the transaction(s) by inputting their personal pin along with the 4-6 digit alphanumeric code or dynamic verification code (DVC) provided to him/her to authenticate the purchase, This code could also be replaced or combined with an ACCEPT/DENY option. This code is time sensitive, which means it times out at a certain point, and the dynamic verification code (DVC) if not correctly inputted, it will generate an error code. The DVC is designed to be used on the specific transaction it was generated or initiated for.

Once the corresponding PIN and dynamic verification code (DVC) is inputted the transaction is approved and the card holder/purchaser will receive a confirmation text to mobile/portable communication device. This transaction is optionally archived in Mobi-SORT (a mobile accounting software application) which is exportable for account filing.

An embodiment of the present invention relates to a method that employs use of this process will be adapted to other forms of verification such as an Individual Personal Credit Information security, Licensing procurement process and Credit line generation process. Security codes and authentication processes, sensitive documentation and information transfer systems, provide security thru validation where triple verification procedures are required.

An another embodiment of the present invention relates to the event of an online purchase using a computer, the user/holder uses VteX³ selects within their preferences online purchases verification. The user is about to checkout, VteX³ sends a alphanumeric 4-6 digit code or QR code depending on the user's account configuration pushed to the user thru his mobile/portable communication device or where the user has the authorized QR code on his/her mobile/portable communication device VteX³app gives approval by retyping the code in the verification code slot along with their pin associated with his/her-account. This then releases the funds from the institution of choice made available by the user which can be finalized from the mobile/portable communication device or on the computer screen.

Another scenario is withdrawal on debit/credit card. The user is at the ATM machine out of state and has selected “Out of State” option on his/her account he go thru the motion of selecting all the correct info and payout amount. Just before he is given the funds a verification request is transmitted [SMS text, DVC code QrCode or ACCEPT/DENY option] to his/her mobile/portable communication device with the pre transaction alphanumeric code or QR code which concludes or requests approval/authorization.

Another aspect of the present invention provides QR Code for VteX³ in the mobile application protocol (MAP) allowing the user to either uses his/her phone to store pertinent or personal information yet giving the user the option or pre verification or post verification.

The QR code holds pertinent or personal info which allows the user to “on request demand easy response”—[ORDER] this information is released allowing the script or string to communicate an encrypted personal transaction code/authorization to the merchant/payment/destination source on behalf of the user/holder.

The post verification option only provides the user/holder with a summary transaction file/report or as specified by the user/holder after the transaction has been completed.

The pre verification requires an additional layer (i.e. if the user has conditional preferences such as out of state, ceiling on purchases or specific purchase times option(s), these are predefined perimeters set by the user. This process eliminates the need to provide at anytime your credit card.

For example, In the case of a restaurant check presented to the user/holder there is a QR code with the merchant's info and charge request or service provider attached to the bottom/top of the check, the user/holder scans this with his or her mobile/portable communication device and depending on the protection level associated with the user/holder (pre/post verified) the bill is paid and the merchant/merchant's representative or service provider has no hand in the transaction(s)

Another aspect of the present invention is multifaceted not just financial based. Its primary function is to keep the user in synchronized, with real-time, verification, authorization or notification—(VaN) choice(s) driven by the user. This is to always prequalify the VaN choices of the information holder. In the case of paying a restaurant check. The user would scan the eQRc or 2 bar code located at the bottom of the receipt. The user then selects the mobile/portable communication device verification authorizing the payment to be made. This is referred to as “Paid Forward” option where the user initiates the payment request from his/her mobile device and the ACCEPT the transaction request which is forwarded to the merchants payment terminal

In accordance with the above and further aspect of the invention, a method is also used to verify Credit info or Guardian Signature. For example 1—the user chooses option type electronic signature on Credit Info Request (non transactional) .This can be simulated where information is request online where the user's credit info is needed similar to an online purchase. The user instead of giving out his/her SSN (social security number) uses his cell number and pin combination or the QR code.

Example 2a (both transactional and non transactional) the user chooses a guardian signature (GS) option—on a transaction/information request for an elderly person. The proxy user receives a DVC, ACCEPT/DENY, Request to review or QRCODE as well as summary request info/transaction allowing this individual to accept or deny the request made

Example 2b (both transactional and non transactional) Example 2a would be used for parental verification control (PVC) option also. Alcohol purchases by a minor on his/her's charge/debit card tied to the user/holder account

Parent or other relations conducting a transaction for products and or services that are questionable (this is where the user opts to have what we refer to as a guardian/Proxy authorization (GPA), which mean the card user has given authorization to an individual/relative who oversee their personal interests. This individual is notified prior to the transaction is executed, is conference into the transaction for approve or not approve such transaction(s).

Another example demonstrates user at a restaurant about to pay his/her bill. The payment roles are reversed and the payee scans QR code which consist of the pre transaction total to the users device the user then chooses from his VteX³ mobile/portable device app the card choice made available to him/her via a dropdown menu, this also allows the user to add the tip if applicable. The payment is then sent back to the Merchant's payment receipt device.

An another embodiment of the present invention will also be referred to as the mobile verification process(MVP) This process will be adapted where real-time Security code combination is used and will also perform and support virtual time/breach management system(s) application(s) relating to offsite management access.

The pre transaction dynamic secure verification code is new to the current structure of financial transaction. There is one way communication, credit card is sent to a processor. But in this method and system transaction will have two-way communication—credit card is sent to VteX³ processor and VteX³ will respond with additional fields to be filled out including but not limited to billing information, verification code, PIN and other pertinent information.

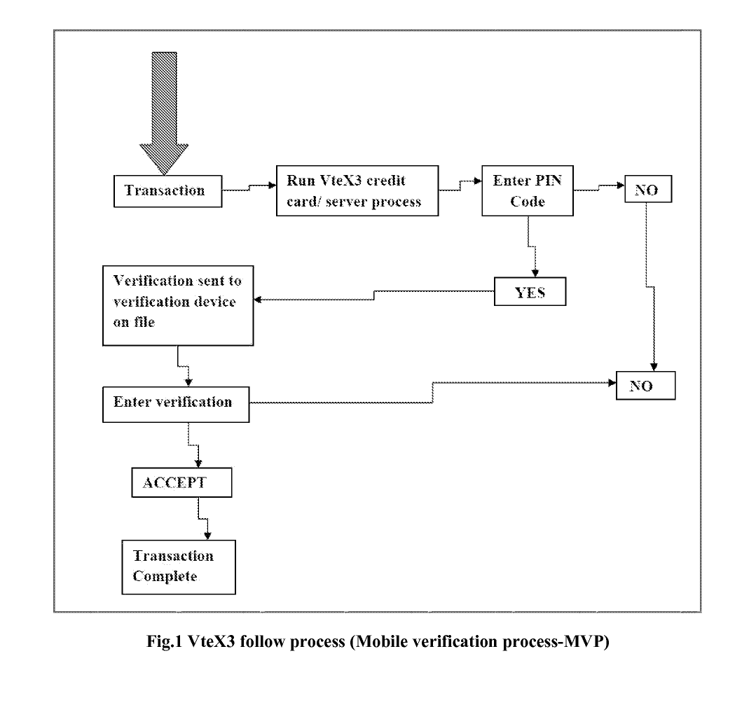

Now referring to FIG. 1, an exemplary embodiment for basic flow of vetx3 application, where the process allows a card holder, purchaser/Information owner to be actively involved in regulating and securing all legal transactions (SALT).

When a “holder” makes a request to conduct purchases online or at a merchant facility such as a supermarket, as well as all other forms of purchases within the retail industry, the cardholder would be provided with a dynamic verification code (DVC) generated from the VteX³ software sent to his/her mobile device which would be written—(thru a unique and proprietary coding encryption) into the purchasing cart/purchasing process of that specific financial institution.

The “holder” would then complete the transaction(s) by inputting their personal pin along with the 4 digit alphanumeric code or dynamic verification code (DVC) provided to him/her to authenticate the purchase. This code is time sensitive, which means it timesout at a certain point, and the dvc if not correctly inputted, will generate an error code. The DVC is designed to be used on the specific transaction it was generated.

Once the corresponding PIN and DVC is inputted the transaction is approved and the card holder/purchaser will receive a confirmation text to his/her mobile device confirming the transaction.

The basic function of this application in purchase controlled process illustrated in tables of the disclosed invention where Table 1, the card holder/user has to provide the specific service group, (i.e. banking institution, Information Center,) with validated information regarding their account. This is accessed by use of an ID username, email address or Social Security number—SSN (last 4 or ail SSN numbers). There is also a pin associated with this information portal. Shows the users account information and is time-stamped by the last log in time and date. It illustrates a SAMPLE LAYOUT of the users' information.

Table 2, Illustrates an example of a shopping cart online and also serves as a Cash register in a retail store as well as a restaurant receipt or any other purchasing format associated with e-commerce.

Table 3, This Table shows the pre-approval stage of the order, purchase or “request made”—(“request made” refers to information updated/requested from say the Credit Bureaus). The user receives an alphanumeric text, a combination of letters and or numbers (provided by the financial/information institution) on his or her mobile/portable communication device which he would input in the verification area provided as well as his/her pin code. This code is referred to as a dynamic verification code (DVC). This DVC is time sensitive and is encrypted to the specific order/request for which it was generated.

Table 4, Illustrates the dynamic verification code (DVC) and Personal Identification Number (PIN) code input stage. Please note when the card holder is required to provide his/her card information over the phone, the merchant or service provider is prompted to choose the card not present option. The dynamic verification code (DVC) generated for this transaction(s) is then provided by the cardholder/user to the merchant or service provider to complete this transaction.

Table 5, illustrates a secured legal transaction process, protecting the 3 important elements of that process. (1) The customer/user, (2) The merchant or service provider, (3) The institution(s) providing the credit/information service. The other 3 important components controlled by the user during any transaction(s) is/are (1) the card information (2) the Personal Identification Number (PIN) (3) the dynamic verification code (DVC) along with medium/mode in communicating this information.

Table 6—shows the email confirmation of the order summary, transaction or request made, and this is all done in real-time.

This process will be adapted where real-time Security code is used and will also perform and support virtual management system(s) application(s).

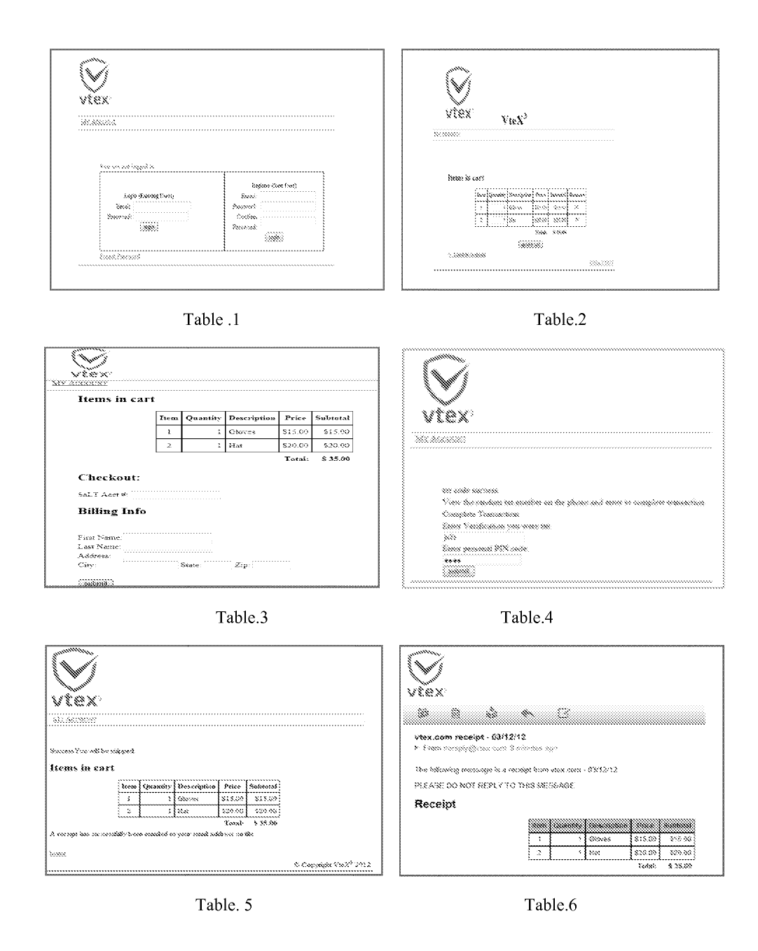

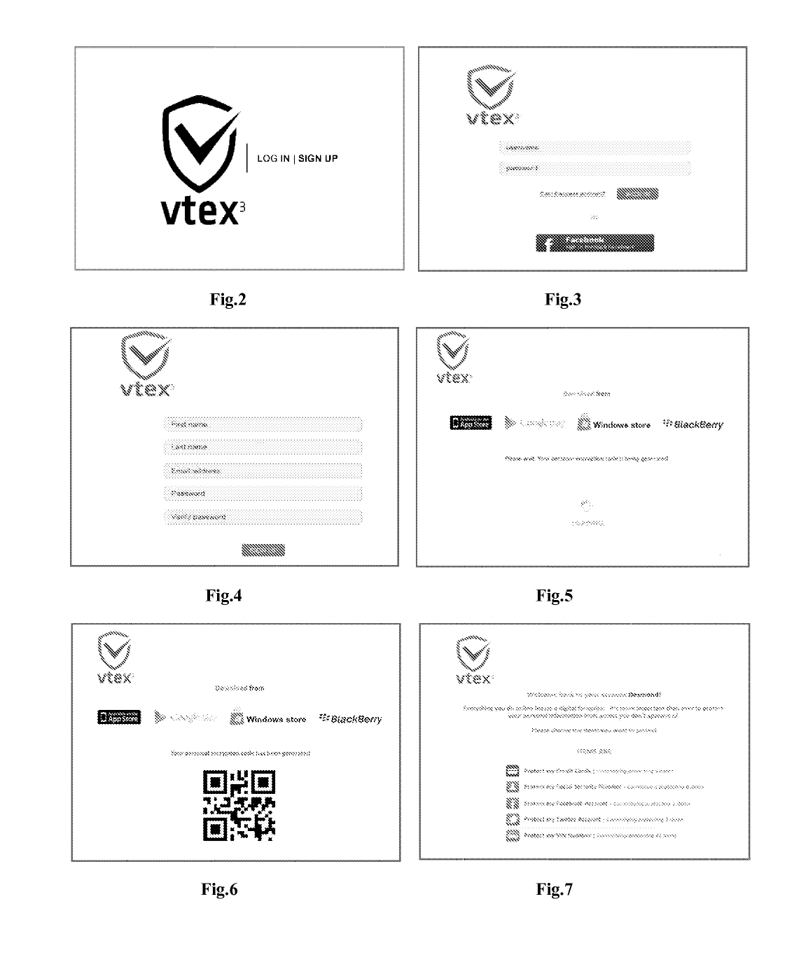

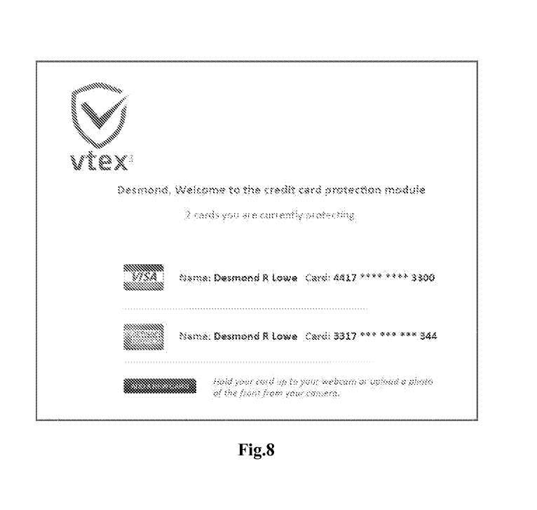

Referring to FIG. 2 to FIG. 8, an exemplary embodiment of fraud protection method and system shown in the block diagram illustrates basic process of functionality chart protecting all transaction/Personal Information Owner (PIO) based requests or personal information includes all card but not limited to credit card, debit card, personal identity card or shopping card are insulated into vtex3 process.

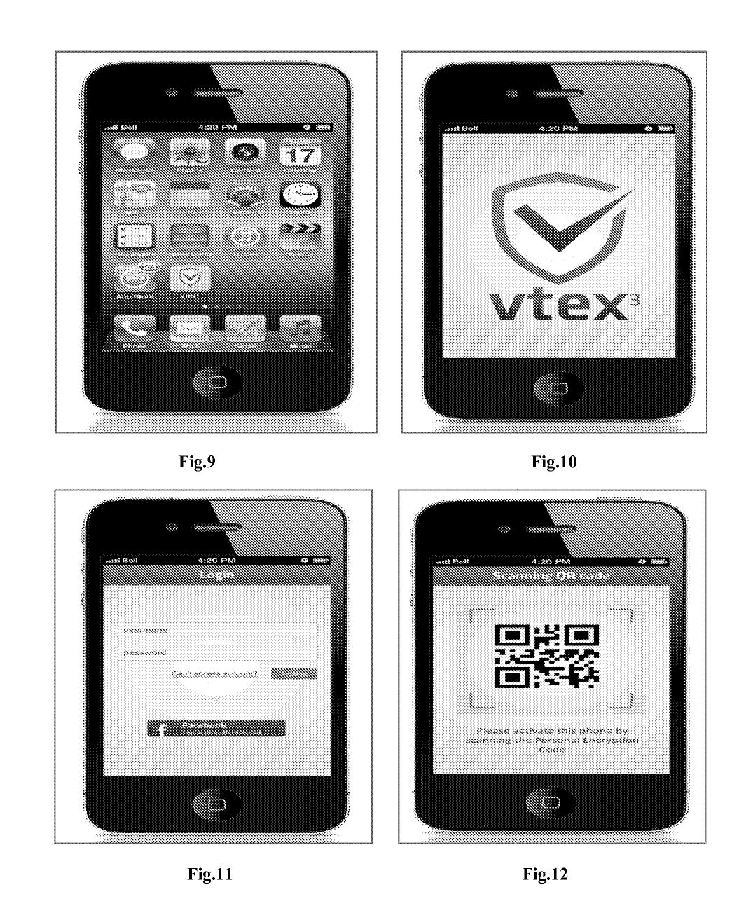

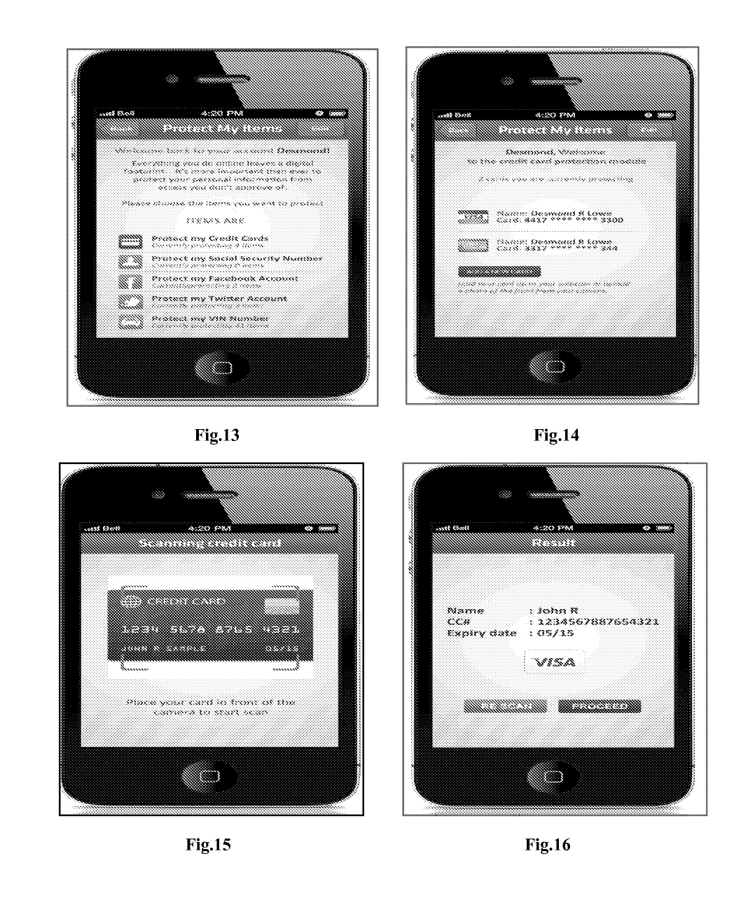

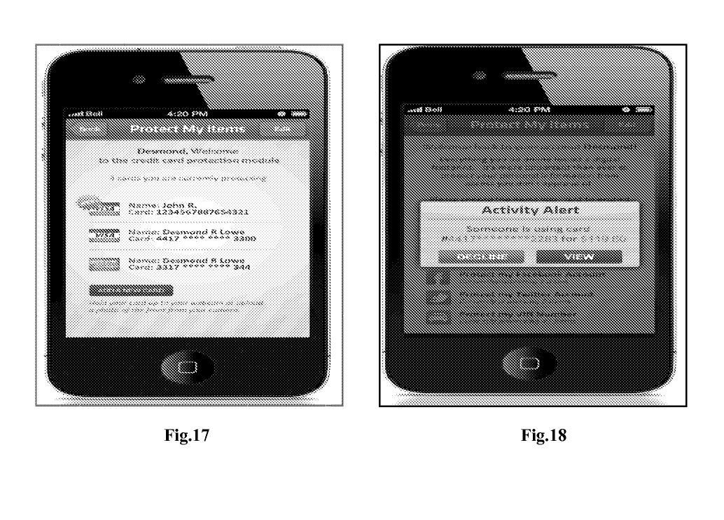

Referring to FIG. 9 to FIG. 18, illustrates vtex3 app in mobile/portable communication device where the process and functional step for protection of all cards and information in VteX3 app installed on his/her mobile are shown. The figures show the process for adapting the software application in mobile/portable communication device for controlling and managing of pre and post verification for all transaction/Personal Information Owner (PIO) based requests or personal information by user; generating a transaction confirmation code based on the received transaction information in response to a transaction for user verification; sending the transaction code for permission to continue the transaction which enables the user to accept or decline the transaction.

An embodiment of the present invention provides phone App only downloadable with a special code from the institution/financial district for authentication purposes. It's a free app but controlled by the institution/financial district. It has triple play process, allowing the holder/user to control 3 of the 4 components of all transaction/request demanded.

The advantages are greater security and information privacy. This risk for a fraudulent transaction will drop significantly. It will require 3 pieces of information data to validate a transaction. One of the pieces is a dynamic verification code (DVC) that is generated per transaction, the second is the PIN code associated with the holder/user's information and the third is the account/customer subscriber (CS) information number. The VteX³ process does not allow for a user's information to be stolen or bypassed. In addition, other validation data is required based on certain security questions, billing information and/or other related validation data.

VteX³ fraud protection system—mobile/portable communication device verification process provides a unique solution to the way an individual's information or monies is transacted. This process is designed to empower the user giving the holder/user full control of how his/her information or monies is shared or transferred.

VteX³ will move into the marketplace as a custom mobile/portable communication device application to complement the VteX³ vision as mobile/portable communication device usage grows exponentially. When VteX³ demonstrates the ease of using their software to process payments and transactions through the user experience, the company can triangulate the Credit Card issuers (Banks), third party credit card processors (i.e. Global Payments) and merchants creating more business for merchants & on-line stores, at less expense while eliminating incidence of credit card hacking and spoilage, it's a “Triple Play”—Game Changing Software.

VteX³ can simply be added or written into existing source code as an enhanced level of proprietary coding encryption used to authenticate and verify transactions. VteX³ will build out its own servers and payment infrastructure to communicate with merchants and banking institutions while processing transactions and insulating for fraud. The VteX³ difference is less expensive than existing payment processing virtually eliminating incidences of spoilage and fraudulent transactions while merchant does not have to wait 7 days or more to receive their money. VteX³ is “Real Time”!

The VteX³ mobile/portable app will build out a multi-platform & backend system with integration capabilities and app marketing packages. They offer endless feature capabilities; extensive quality testing, an all-around cost effective resource at a reasonable price.

One skilled in the art will appreciate that the embodiments provided above are exemplary and in no way limit the present invention.

Although the invention has been illustrated and described with respect to one or more implementations, equivalent alterations and modifications will occur to others skilled in the art upon the reading and understanding of this specification and the annexed drawings. In addition, while a particular feature of the invention may have been disclosed with respect to only one of several implementations, such feature may be combined with one or more other features of the other implementations as may be desired and advantageous for any given or particular application.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

The Abstract of the disclosure will allow the reader to quickly ascertain the nature of the technical disclosure. It is submitted with the understanding that it will not be used to interpret or limit the scope or meaning of the following claims.

What is claimed is:

1. A method for providing fraud protection and prevention of Identity theft, referred to as Personal Information Owner (PIO), where an authorized user is linked to a transaction, info request or access granted via a highly secure software application , the method comprising:
storing and editing of card holder or user's information into an application server;
controlling and managing of pre and post verification for all transaction/Personal Information Owner (PIO) based requests or personal information;
generating a transaction confirmation code based on the received transaction information in response to a transaction for user verification;
sending the transaction code for permission to continue the transaction enabling the user to accept or decline the transaction;
transmitting authentication preparation and confirmation step, information obtained from user to payment gateway server for sequential processing ;
requesting transaction confirming request, confirmation of transaction by user; and
providing electronic transaction details or summary receipt for evaluation by user.

2. The method of claim 1, wherein the card/Personal Information Owner (PIO) includes all card but not limited to credit card, debit card, personal identity card or shopping card

3. The method of claim 1, wherein the said user is authorized person of account or card.

4. The method of claim 1, wherein storing and editing in which additional fields to be filled including but not limited to billing information, verification code, PIN and other pertinent information.

5. The method of claim 1, wherein the said software application is installed on user mobile/portable communication devices, where the dynamic verification code (DVC) encoded in QR Code information is sent to user which authenticates and validates the transaction prior to processing it.

6. The method of claim 1, comprising designing to empower the user, giving the holder/user full control of how information or monies are shared or transferred.

7. The method of claim 1, wherein authentication preparation and confirmation step user has to input a 4-6 digit code specific to a particular monitoring option at end of all transaction/Personal Information Owner (PIO).

8. The method of claim 1, comprising insulation of all cards, from potential liability under a protective shield, where protection is the holder or users from fraud acting as a form of insurance between them and third parties.

9. A method for providing fraud protection to user, verifying authorization of a person . identification through mobile verification protocol (MVP), providing card holder or user with pre and post verification for all transactions or personal information updates, inputs, changes or anything specific to holder or user , the method comprising:
creating preferences for information of account or personal information, personal identification number and dynamic verification code (DVC);
providing authorization security for all financial transaction including but not limited to credit card transactions;
alerting user regarding transaction, where notification is transferred to user mobile/portable communication device application from the moment transaction initiated;
validating and verifying authorization for each transaction; and a response returned as to success or failure related to transaction information provided by user to merchant server;
wherein mobile verification protocol(MVP) also provides assistance to physically challenged and the disabled to be able to use services via TTY operator to communicate.

10. The method of claim 9, wherein account/personal information, personal identification number (PIN) and dynamic verification code which is an alphanumeric code provided at the time of request via his or her mobile/portable communication device or verification media.

11. The method of claim 9, wherein the dynamic verification code (DVC) is generated per transaction, the PIN code associated with the holder/user's information and the account/customer subscriber (CS) information number.

12. The method of claim 9, wherein the transaction is validated and verified, a response will be returned as to success or failure related to transaction information shared.

13. The method of claim 9, wherein the dynamic verification code (DVC) is time sensitive.

14. A mobile/portable communication device server application containing a program which provides protection against fraud, when executed, performs an operation, comprising:
collecting information about a user personal information, personal identification number and dynamic verification code (DVC);
securing user information to define transaction management criteria while the application provides full authority to personalize their transaction according to their use;
controlling and validating of authorization of each transaction by user;
creating associations among merchant, payment gateway and user; and
the monitoring and managing of all transactions are by end user.

15. The method of claim 14, wherein the pre verification requires an addition layer i.e. if the user has conditional preferences such as our state, ceiling on purchases or specific purchase times option (s), there are predefined perimeters set by user.

16. The method of claim 14, comprising creating preferences and or authorization option as he/she chooses, such preferences includes; out of state charges, online charge shipped to different address than the user, cash withdrawals outside of a specific zip code or state, transaction over a specific amount, online purchases where verification is done using a 4-6 alphanumeric code per transaction and or QR code.

17. The method of claims 1 to 16, comprising creating a continuous electronic footprint between e-commerce and e-information.

18. The method of claims 1 to 16, wherein the method restores the confidence as e-information is shared.

19. A method for providing full control of confidential information by managing such information to user by multistep verification process (MVP), the method comprising:
performing a step of registering information capable of specifying the association between said real person and application server;
storing holder or user's information into an application server and application associated with customer mobile/portable communication device;
receiving of an information verification request from a requesting entity;
authenticating information verification request;
transmitting an verification code to mobile/portable communication device associated with customer, wherein the response of the request of authorization is communicated to a requesting entity;
and transmitting at least one identification credential associated with the customer to requesting entity's virtual terminal.

20. The method of claim 19, wherein the information includes such as social security, proxy and guardian option enabled on services or data but not limited to social media, check cashing, e-document or mortgage papers.

21. A method for providing full disclosure of confidential information by managing such information of user thru Institution Verification Process (IVP), the method comprising of:
a user/holder making a call to an institution wherc his/her information has MVP [mobile/portable verification protocol] associated to such account,
process assists the intuition in qualifying thru MD-verify (mobile device verification) is conducted without alerting the user or explaining how and what MD-verify works) the user/holder while protecting the owner's personal information.

22. The method of claim 21, wherein the mobile verification protocol is designed to proactively assist, notify, verify and alert the PIO [Personal Information Owner] to be included in the Institution Verification Process (IVP) or usage of his/her information.

23. The method of claim 1-22, wherein the method uses two way communications in authorization process creating a real-time validation.

24. A method for providing full control on transactions involving personal identity information of the user or card holder by managing or modifying preferences through authorization process, the method comprises of preauthorization request on specific transaction, exception notification, and authorization option as he/she chooses, such preferences include but not limited to: out of state charges, cash withdrawals or transaction outside geographic restrictions, transaction over a specific amount, timeline uses online purchases where user or card holder pre-authorizes, pre-informs or pre-notifies the issuer or bank by initiating request in real time except push notification accompanied by his or her pin number of such specific transaction through mobile/portable communication device. “</U>”
